(19) United States
(12) Patent Application Publication
(10) Pub. No.: US 2010/0110181 A1
(43) Pub. Date: May 6, 2010

(54) Passive Positioning Information Of a Camera In large Studio Environment

(76) Inventors: Yong Wang, Princeton, NJ (US); Yang Guo, Plainsboro, NJ (US); Saurabh Mathur, Monmouth Junction, NJ (US); Kumar Ramaswamy, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/451,471

(22) PCT Filed: May 17, 2007
(86) PCT No.: PCT/US2007/011826

§ 371 Date: Nov. 13, 2009

(51) Int. Cl. H04N 7/18; G06F 15/00

(52) U.S. Cl. 348/140; 702/150; 348/E07.085

(57) ABSTRACT

In one embodiment of the present invention, a method includes locating at least one transmitter on at least one movable camera for transmitting a signal detectable by receivers located in fixed positions for distance measurements of the camera with respect to the receivers for location processing of the distance measurements. The method can further include detecting out of range measurements from collected range measurements based on receivers in known locations as an indication of the movement of a transmitter responsive to signals from the transmitter.

### FIELD OF THE INVENTION

The present invention generally relates to location information systems and more particularly to positioning information of a camera in a studio environment.

### BACKGROUND OF THE INVENTION

Measuring the precise position and orientation of each studio camera is essential to any virtual media production system that renders the virtual scene from the appropriate viewpoint. Current systems can achieve an accuracy of up to 2 millimeters. However, there are several limitations to these systems. First, the cost of building such a system is usually in the order of 100,000 US Dollars. Second, calibration is required before the system can be used and this process involves a lot of human effort:

Recent advances in wireless sensor networks enable a new approach for localizations. There is a large literature on localizations using sensor networks and many algorithms have been proposed to provide per-node position information. These methods can be divided into two categories: range-based and range free. Range based positioning requires point-to-point distance estimates (range) or angle estimates while range free positioning does not assume any such information. Due to the accuracy limits of range-free based protocols, they are not suitable for most media production applications, therefore, only range-based positioning methods are suitable for positioning in a studio environment.

The Cricket Location Support System is one of the few commercial sensor nodes equipped with an ultrasound transceiver, which has been shown to be effective in achieving high accuracy in indoor ranging estimations. Since ranging accuracy is of crucial importance to positioning accuracy, the Cricket system is a good candidate for positioning in media production applications. Second, the off-the-shelf Cricket system already provides a base system with high localization accuracy that we can be used to build a localization system on.

The Cricket system uses a range-based method for localization and has a reported accuracy of 3 centimeters. Cricket uses beacons with ultrasound (US) and Radio Frequency (RF) emitters as a reference system to triangulate the position of the node to be localized (listener). The distances from the listener to the beacons are measured using the time difference of arrivals (TDOA) of the ultrasonic signals and RF signals. This achieves a better ranging estimation than using Received Signal Strength (RSS) alone.

An extensive evaluation of the Cricket system, in an indoor environment, shows that the original Cricket system achieves an accuracy of from 2 cm to 10 cm for a variety of tests. This is not satisfactory for media production applications. Indoor localization using sensor networks has its potential but also limitations. Localization of cameras in a studio environment has different requirements and challenges compared to other indoor localization systems. These include (1) large studio space, (2) small number of nodes to be localized, and (3) a need for high accuracy positioning.

Accordingly, there is a need for a localization technique that overcomes limitations of existing localization systems to accommodate the unique characteristics and requirements in a studio environment.

### SUMMARY OF THE INVENTION

In an aspect of the invention a method includes detecting range measurements that are unacceptable as an indication of movement of a transmitter from collected range measurements based on receivers in known locations responsive to signals from the transmitter.

In another aspect of the invention, an apparatus includes a station for receiving collected range measurements of a transmitter and detecting which of the range measurements are unacceptable as an indication of movement of the transmitter.

In a further aspect of the invention, a method includes locating at least one transmitter on at least one movable camera for transmitting a signal detectable by receivers located in fixed positions for distance measurements of the camera with respect to the receivers for location processing of the distance measurements.

In a yet further aspect of the invention, an apparatus includes at least one transmitter for at least one movable camera for transmitting a signal detectable by receivers positioned for distance measurements of the camera with respect to the receivers for processing of the distance measurements.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a diagram depicting a localization technique in a passive mode of operation in accordance with the invention;

FIG. 2 is a diagram of limitations of alignment of ultrasound transmitters of a Cricket location system which the invention overcomes; and

FIG. 3 is a flow diagram of an outlier detection process in a localization phase in accordance with the invention.

It should be understood that the drawings are for purposes of illustrating the concepts of the invention and are not necessarily the only possible configuration for illustrating the invention.

### DETAILED DESCRIPTION OF THE INVENTION

The present invention is directed to supporting passive localization in a studio environment. The inventive positioning achieves accurate ranging estimations and offloads the localization algorithms to a later phase. Since localization with the invention is used for post-processing, communication is necessary only one-way, e.g., from the node to be localized to the anchor nodes, and this introduces no extra overhead to the original system. The invention further improves localization accuracy by mitigating the interference of range estimations at the listener side. The inventive localization is adaptive to select the most reliable anchor nodes for node localization, which is more resource-efficient and produces more stable results for static nodes.

The active mode adopted by the current Cricket system is not suitable to achieve high accuracy due to the limited bandwidth of wireless transceivers, the limitation of directional ultrasound transmissions, and overlap between radio frequencies RFs and ultrasounds USs. Based on the characteristics of media production applications, such as the small number of cameras and potential large studio size, it is preferable to let the node to be localized to emit beacons for range estimation and the localization is conducted offline during the post-processing phase.

The invention provides high-accuracy camera localization in a large studio environment where typically two or three cameras need to be positioned. It improves on the Cricket positioning system by mitigating the interference and outlier problems. To address the instability problems of a least square estimator in a static environment, the invention employs an adaptive anchor selection algorithm that achieves stability by filtering out range estimations that are unreliable.

A studio environment can be characterized as small number of cameras, large indoor space and positioning for media production applications has a requirement for high accuracy at each location. This is a very different design goal from conventional positioning system using sensor networks whose accuracy is in the order of 10 cm. A camera positioning system should allow unconstrained movement of a camera over the entire studio space and measure camera positions to a sufficient accuracy to minimize the drift or noise in the relative positions of the real and virtual elements of the scene.

Many indoor localization systems have already been developed for different purposes. The preferred embodiment of the invention employs the Cricket system because it is commercially available and can achieve a positioning accuracy up to 10 cm. In the Cricket system, nodes are divided into two categories: those to be positioned and those to be used as anchors.

The anchor nodes do not move once they are placed. The anchors nodes periodically send out beacon messages containing their positions and ultrasound US signals immediately following the RF signals. The listener estimates its distance to the anchors based on a time difference of arrivals TDOA and then uses a multi-lateration algorithm to estimate its position based on ranges to at least three anchors with their positions known. Since the number of anchors is determined after the system is deployed using Cricket, this requirement is easily satisfied. A significant challenge encountered by the Cricket system is in-band interference. This refers to the interference between radio transmissions and the interference of ultrasounds USs when calculating the time difference of arrivals TDOA between a pair of radio frequency RF and ultrasound US signals. This makes it very hard to further improve its accuracy for camera position location in a large studio environment.

The invention mitigates the inaccuracies with the Cricket system by taking advantage of the unique characteristics of a studio environment. It allows applications running on mobile and static nodes (such as cameras) to learn their physical location by using listeners spread throughout the building (such as mounted on the ceiling) that hear and analyze information from beacons whose position are to be determined.

This is different from the original Cricket design in that the nodes to be localized now act as beacons. On one hand, due to the small number of cameras to be positioned, the beacon transmissions do not pose any scalability problems to the network. On the other hand, since position data is usually exclusively for post-processing, the localization can be postponed to the post-processing phase and all range measurements are now collected to a central server for processing. This allows for more sophisticated localization algorithms and range estimation filters to achieve higher accuracy in node positioning. Our design takes into account the delay-tolerant properties of a wide range of media production applications to further improve their positioning accuracy.

The inventive procedure for camera positioning using a Cricket system in a studio environment includes programming the anchor nodes to be in listener mode, programming the nodes to be used as beacons and measuring the time difference of arrival of a pair of radio frequency RF and ultrasound US pulse.

The anchor nodes are programmed to be in listener mode and deployed on a ceiling to cover the studio where cameras are to be positioned. The placement of anchors considers geometry constrains so that the localization algorithm can later produce a solution. This step may have human involvement. The positions of anchors nodes are known, either through a manual setup process or an automatic calibration process.

The nodes to be positioned as a beacon are used to periodically send out a radio frequency RF signal immediately followed by an ultrasound US pulse. The radio frequency RF signal also contains time-keeping information with regard to when this pair of signal is transmitted which is used later during the post-processing to map the position of the camera with its relative timestamps.

By measuring the TDOA of a pair of radio frequency RF signal and ultrasound US pulse, each anchor node can estimate its distance to the camera. Such range measurements are collected at the base station for camera positioning in the scene, described in greater detail below. The accuracy of positioning relies on enough number of range measurements and the accuracy of range measurements, described in greater detail below.

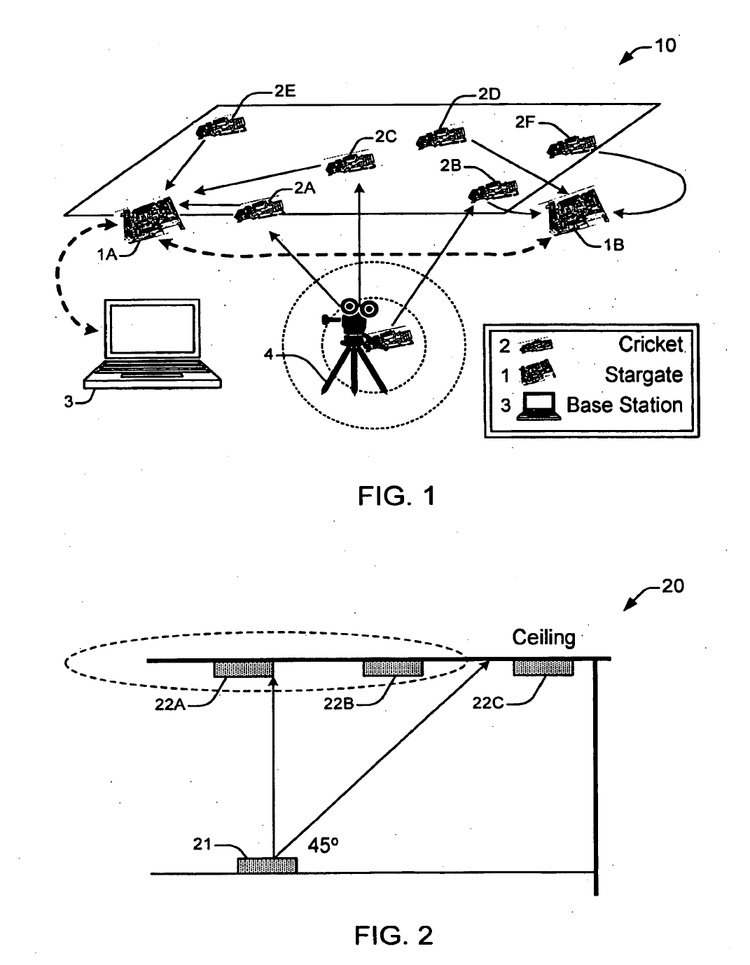

The diagram 10 of FIG. 1 shows an exemplary configuration of the inventive localization system in passive mode using the Cricket system. The beacon is attached to the camera 4 to be positioned and the anchors 2A-2F are placed on the ceiling in the studio. The Stargate nodes 1A and 1B aggregate range estimation traffic and forward them to the base station 3 using a wireless link. Localization is conducted at the base station 3 when all the range estimations at different times are collected.

The Stargate node is low-power, small-size, 400 MHz, Linux Single Board Computer. The Stargate is a powerful single board computer with enhanced communications and sensor signal processing capabilities. The Stargate uses Intel's® latest generation 400 MHz X-Scale® processor (PXA255). Stargate directly supports applications around Intel's Open-Source Robotics initiative as well as TinyOS-based Wireless Sensor Networks.

The range measurements are collected at the base station. Positioning does not need to be conducted at real-time and range measurements only need to be collected at the base station before the localization phase. This allows for a more efficient data collection routing protocol to be used, rather than communicating position data at real-time as it does in the active mode. An exemplary range data collection protocol can entail that all range estimations are time-stamped based on the clock of the node at the camera side, i.e., the beacon, and sent periodically to some cluster nodes 2A,2B. When enough range data are aggregated at the cluster nodes, they forward the data to the base station using their wireless link. This has been proven to be a much more energy-efficient approach and introduces zero interference to the localization traffic.

No time synchronization is needed between the anchors and the beacons in the inventive process because range measurements are identified solely by time-stamps at the beacon side that are unique given that different beacons can be identified, such as using unique identifications for different beacons. Later during the localization phase, only a mapping between a local clock and the beacon-side time-stamps is necessary to calculate the locations of the beacon node. However, due to various interference and real-world factors, beacons may be lost or delayed that in turn leads to loss or inaccuracy in range measurement if the nodes are moving. A coarse-grain synchronization between anchors and beacons is useful. The timely arrived beacons are used for synchronization and to interpolate lost range measurements in between. This works well when missing beacons are in low numbers. Given a very severe environment where an anchor and a beacon are significantly unsynchronized, any existing synchronization techniques can be used to bootstrap the synchronization between them.

Range measurement outliers filtering takes into account that since the beacon nodes are now the nodes to be localized and the number of beacons is small, in-band interference is minimized. Specifically, only consideration need be given for when a reflection of the ultrasound US pulse from beacon A arrives while the radio frequency RF signal from beacon A is being received: RF-A,US-RA. The Cricket system solves this problem by aligning the ultrasound transmitter to a specific position such that the leakage of ultrasound to positions not covered is reduced.

The diagram 20 of FIG. 2 illustrates the limitations of the Cricket ultrasound transmitter 21. Since the transmitter 21 is aligned to have the strongest energy towards anchors 22A,22B within its 45 degree direction sweep, any anchor 22C outside the covered area will be affected by the multi-path interference problem which leads to inaccurate range measurement. This has been verified by experimental evaluation. By carefully selecting the anchors 22A,22B that are within the covered area of the beacon, the interference problem from reflected ultrasound pulses is mitigated. However, this approach has several problems. For a large studio space, range measurements from anchors to a node not within the covered area are error-prone to this type of interference. This is hard to identify using the active mode of localization since it is difficult to filter out these range estimations on-the-fly without seeing all ranges.

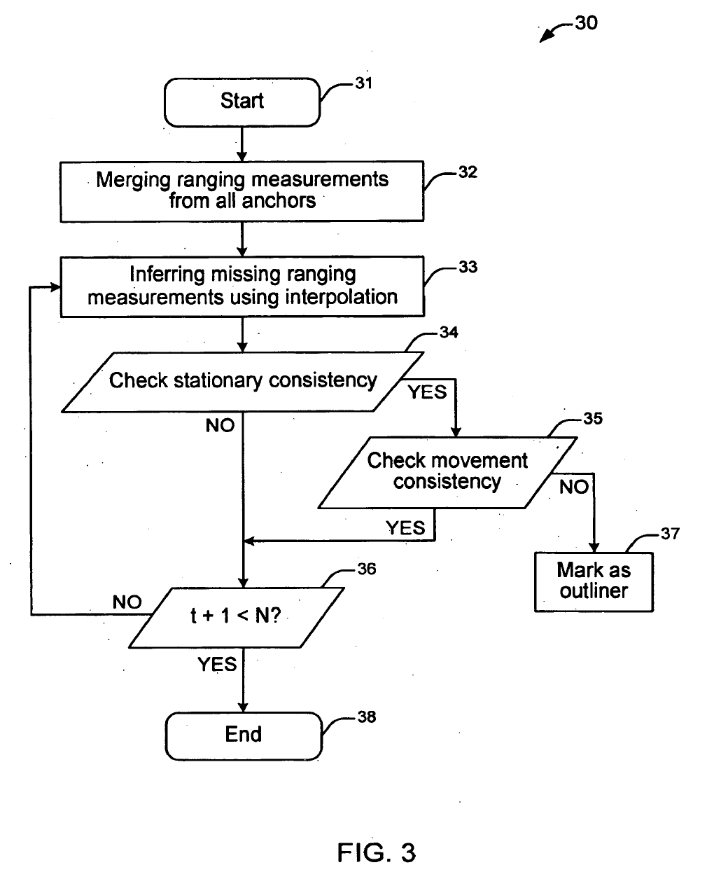

With the inventive approach, after passively collecting all the range measurements, statistics can be used to filter out those outliers that introduce large errors. The flow diagram 30 of FIG. 3 demonstrates the process used for range measurement outlier detection. The process starts 31 with a merging of ranging measurements from all anchors 32. Interpolation is used to infer missing ranging measurements 33. If there is no stationary consistency 34 then the measurement is likely an outlier movement consistency 35 is checked. The ranging measurement is noted as an outlier measurement 37 if there is no movement consistency. If there is no stationary consistency 34 and recursive interpolation a number of predetermined times, e.g., t+1<N, has not produced a stationary consistency the process is ended 38. Otherwise interpolation is used again to infer missing ranging measurements and the process is repeated for detecting an outlier ranging measurement.

With the process of FIG. 3, two main constraints are considered when detecting outliers: stationary consistency 34 and movement consistency 35. Stationary consistency means that the range estimation should be stable to a particular anchor if the beacon is stationary. Any large difference in range measurements indicates an outlier if the beacon is not moving. Movement consistency means that the range measurements from all or a large percentage of the anchors should be spatially consistent. Spatial consistency is defined here as the actual geometry distance constraints that the beacon should follow with regard to the anchors. If a range estimation to one anchor is not stationary consistent, it is likely that this is an outlier or that this is due to beacon movement. We will then mark this range measurement as outlier candidates and test the movement consistency 35. Only if a measurement at this timestamp is consistent movement is it actually treated as an outlier. In this way, an account is taken of the impact of both node movement and various interferences to range estimations, which leads to a higher accuracy in outlier detections.

As shown, the invention builds upon the low-cost and commercially-available localization system, Cricket, by employing a passive localization mode that leverages the unique characteristics of the studio environment to further improve positioning accuracy. The Cricket system can achieve an accuracy of 2-10 cm which is not suitable for media production applications.

The invention further improves positioning accuracy in a studio environment where an accuracy of 2 mm is required. The invention is a simple yet effective new architecture that further increases the positioning accuracy compared to the current Cricket system.

The invention also maintains the low-cost benefits of such a positioning system using sensor networks. The invention is a high accuracy positioning system that leverages application and targeted environmental characteristics. With the invention, beacons are now sent in a reverse direction back to the anchor nodes and localization is conducted offline after time-stamped range estimations are collected to a central server, the interference between different radio frequencies RFs and ultrasounds USs and between ultrasounds USs and ultrasounds USs are minimized. The invention mitigates the interference problems inherent in the original Cricket system which leads to an improvement in positioning accuracy without compromising other important metrics, such as cost, energy and human efforts.

Having described a preferred embodiment for accurate wireless based camera location and orientation, it is noted that modifications and variations can be made by persons skilled in the art in light of the above teachings. For example, the cluster node shown is a Stargate node from Intel 2A,2B. The Stargate node is merely exemplary and shown to aid an understanding of the invention and other node types can be used as cluster nodes. An exemplary wireless connection for communication to and from the cluster nodes 2A,2B is a WI-FI or 802.11 compliant link. However, other wireless communication links can be used.

Having thus described the invention with the details and particularity required by the patent laws, what is claimed and desired protected by Letters Patent is set forth in the appended claims.

1. A method comprising the step of:
detecting range measurements that are unacceptable as an indication of movement of a transmitter from collected range measurements based on receivers in known locations responsive to signals from the transmitter.

2. The method of claim 1, further comprising the step of filtering out the unacceptable range measurements.

3. The method of claim 1, wherein the step of detecting comprises looking for stability in a collected one of the range measurements based on the transmitter being stationary.

4. The method of claim 1, wherein a large difference in the range measurements associated with the transmitter being stationary is indicative of an error.

5. The method of claim 1, wherein the step of detecting comprises looking at one of the range measurements for spatial consistency.

6. The method of claim 1, wherein the step of detecting comprises looking at one of the range measurements for geometric distance constraints that the transmitter should follow when moving with respect to the receivers.

7. The method of claim 1, wherein the step of detecting comprises looking at movement consistency, of one of the range measurements that lacks spatial consistency.

8. The method of claim 7, wherein the movement consistency means that the range measurements from a certain number of the receivers should be spatially consistent.

9. An apparatus comprising:
a station for receiving collected range measurements of a transmitter and detecting which of the range measurements are unacceptable as an indication of movement of the transmitter.

10. The apparatus of claim 9, wherein the station is configured for filtering out the unacceptable range measurements.

11. The apparatus of claim 9, wherein the station is configured for looking for stability in a collected one of the range measurements based on the transmitter being stationary.

12. The apparatus of claim 9, wherein the station is configured to look for a large difference in the range measurements associated with the transmitter being stationary as indicative of an error.

13. The apparatus of claim 9, wherein the station is configured looking at one of the range measurements for spatial consistency.

14. The apparatus of claim 9, wherein the station is configured for looking at one of the range measurements for geometric distance constraints that the transmitter should follow when moving with respect to the receivers.

15. The apparatus of claim 9, wherein the station is configured for looking at movement consistency of one of the range measurements that lacks spatial consistency.

16. The apparatus of claim 15, wherein the movement consistency means that the range measurements from a certain number of the receivers should be spatially consistent.

17. The apparatus of claim 9, wherein the station is a server receiving the collected range measurements wirelessly.

18. The apparatus of claim 9, wherein the station is a computer receiving the collected range measurements from a Cricket positioning system.

19. The apparatus of claim 9, wherein the range measurements are time stamped.

20. A method comprising the steps of:
associating at least one transmitter for at least one movable camera for transmitting a signal detectable by receivers positioned for distance measurements of the camera with respect to the receivers for processing of the distance measurements.

21. The method of claim 20, further comprising the step of collecting the distance measurements periodically for transmission to a central server for location processing to attain camera positioning.

22. The method of claim 20, wherein the transmitter is a beacon of a Cricket system.

23. The method of claim 20, wherein the receivers are anchors of a Cricket system.

24. The method of claim 20, wherein the receivers are positioned on a roof of a studio environment.

25. The method of claim 20, wherein the distance measurements are collected for range estimation filtering to attain camera positioning.

26. The method of claim 20, wherein the at least one camera comprises multiple cameras movable in a studio environment.

27. An apparatus comprising:
at least one transmitter for at least one movable camera for transmitting a signal detectable by receivers positioned for distance measurements of the camera with respect to the receivers for location processing of the distance measurements.

28. The apparatus of claim 27, wherein the at least one transmitter is multiple transmitters for respective multiple cameras movable in a studio environment.
